(19) United States
(12) Patent Application Publication
(10) Pub. No.: US 2004/0038608 A1
(43) Pub. Date: Feb. 26, 2004

(54) Sorbent material for petroleum/oils or for water-soluble pollutants

(75) Inventors: Wayne E. Shaw, Glenn Mills, PA (US); Mark Trabbold, Harleysville, PA (US); Kenneth D. Knapp, Norristown, PA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: SAINT-GOBAIN ISOVER, Courbevoie (FR)

(21) Appl. No.: 10/648,394

(22) Filed: Aug. 27, 2003

Related U.S. Application Data
(63) Continuation of application No. 09/821,453, filed on Jun. 25, 2001.
Application No. 09/821,453 is a 371 of international application No. PCT/FR00/02254, filed on Aug. 4, 2000.

(51) Int. Cl. B32B 27/04; B32B 5/02; B32B 27/12

(52) U.S. Cl. 442/118; 442/121; 442/172; 442/152; 442/157

(57) ABSTRACT

The subject of the invention is a “sorbent” material comprising a fibrous material which, in a first variant, comprises an oleophilic coating and, in a second variant, is combined with a hydrophilic particulate material.

The invention also relates to the methods for their production and their applications.

The present invention relates in general to sorbent materials and in particular, in a first variant, to appropriate oleophilic materials for the absorption and/or adsorption of petroleum/oils, as well as to appropriate sorbent materials for the absorption of water (or of solvent(s)) in which polluting agents are dissolved.

Accidental spills of crude and refined petroleum, of petrol and of similar products, most especially in watercourses, have the potential of inflicting considerable damage on the ecosystem. If a spill is large in size, the local populations of mammals, the aquatic organisms and other animals and plants may be endangered. A large number of techniques known for the elimination or attenuation of the impact of spills of this type may be costly and take a lot of time. Their efficacy can furthermore be unsatisfactory and these techniques can cause secondary problems. The inflammation of slicks of hydrocarbons on water or on the ground may for example be dangerous for people or property just as for the surrounding animal and plant life. Agents for dispersing petroleum and detergents often produce residual derivatives which may themselves be dangerous. Because of these inadequacies, sorbent materials often represent an attractive alternative for the purpose of cleaning spills of petroleum or of similar products. As used here, terms such as “sorbent” and the like should be understood to include materials which “absorb” and/or “adsorb” liquids. In some cases, however, where appropriate for clarity of explanation, the present text will specifically indicate if phenomena involving “the absorption capacity” or “the adsorption capacity” are present and if one or the other predominates.

Sorbent materials which have manifested a potential as effective means of treating aquatic and nonaquatic hydrocarbon slicks include fibres and mineral and glass particles. U.S. Pat. No. 5,215,407, for example, proposes the use of blowing wool compositions based on fibreglass, shredded or nonshredded, for the treatment of spills of petroleum situated on bodies of water or on the ground. This patent asserts that one advantage of the use of materials of this type on water is the fact that if an appropriate fibreglass insulating material is used, the fibreglass manifests sorption affinity for the petroleum rather than for the water. Because of the inorganic nature of fibreglass blowing insulating materials, materials of this type “adsorb” more than they “absorb” liquids. The fibreglass compositions disclosed in U.S. Pat. No. 5,215,407 are essentially composed of fibreglass blowing insulating materials with the possible inclusion of cork and/or styrofoam to provide absorption capacity and resistance to compression. The fibreglass may also be sprayed with the aid of a fog generated from a solution of antifreeze and water, in order to reduce the static electricity and the dust released during the spraying of the particles onto a petroleum spill.

U.S. Pat. No. 5,215,407 mentions several commercially available materials which are appropriate for use as base for the particles of a fibreglass blowing wool composition which are disclosed therein: fibreglass blowing insulating material InsulSafe III®, manufactured by the company CertainTeed Corporation, of Valley Forge, in Pennsylvania, fibreglass blowing insulating material Rich-R®, manufactured by the company Johns Manville Corporation, of Denver, in Colorado, and fibreglass blowing insulating material Thermacube®, manufactured by the company Owens Corning, of Toledo, in Ohio. For aquatic petroleum spill applications, the patent apparently recommends the use of fibreglass blowing insulating material InsulSafe III®, because it does not have a tendency to absorb water. In relative terms, compared with the fibreglass blowing insulating materials Rich-R® and Thermacube®, the fibreglass blowing insulating material InsulSafe III® may absorb less water. It nevertheless does not constitute a material which is genuinely hydrophobic.

The fibreglass blowing insulating material InsulSafe III® is a bulk fibreglass insulating material, with unbound, white, virgin fibres, which is applied with the aid of pneumatic means for the insulation of lofts, wall surfaces and other areas of a building. To facilitate the introduction and to improve the performance of the insulating material in its specialized building insulation applications, the fibreglass is coated with several materials designed to achieve certain results or certain beneficial properties. Among these are silicone emulsions which act as lubricant and quaternary ammonium salts which act as antistatic agent. Silicone is a protective coating on glass (that is to say that it prevents abrasion of the fibres through mutual rubbing of one fibre on the other). Silicone improves recovery during the blowing process (that is to say gives again resistance to the fibre so as to reach a high R value).

It has been demonstrated that the fibreglass blowing insulating material InsulSafe III®, just like the fibreglass blowing insulating material Thermacube® (which is recognized in U.S. Pat. No. 5,215,407 as being even more hydro-sorbent than the fibreglass blowing insulating material InsulSafe III®), sinks rapidly if used to treat an aquatic hydrocarbon slick. The material for treating petroleum spill which has sunk can, in some cases, be difficult if not impossible to recover. This can in turn lead to an ecological contamination of the marine environment in the vicinity of the material which has sunk.

U.S. Pat. No. 5,078,890 describes a technique for treating an aquatic petroleum spill by the use of felt particles made of mineral wools (glass wool or rock wool). The mineral wools are bound by a hydrophobic formophenolic binder resin and are hardened at high temperature. The felts are cut into particles of less than 4 cm and are then compressed in order to reduce their volume during storage and transport. At the time of application, the densified particles are decompressed and unbound and are then sprayed onto a petroleum spill by a pneumatic stream, such that they recover their original density. Silicone or similar hydrophobic agents may be made available in addition to the binder resin at the time of the manufacture of the felts in a proportion of approximately 0.5 to 3.0 percent by weight of the fibreglass. The product described in U.S. Pat. No. 5,078,890 is marketed by the company Saint-Gobain Isover, in France. It is oleophilic and hydrophobic and floats on water and is consequently useful for its future applications. Its method of manufacture and the subsequent techniques for handling and use are nevertheless somewhat complicated and demanding from the material, energy and financial point of view.

Fibreglass was proposed for its use as a means for cleaning or absorbing accidental spills of petroleum on the ground and on water. U.S. Pat. No. 5,078,890, as cited above, describes the use of a commercially available bulk fibreglass insulating material for the purpose of objectives of this type. However, the coating substances applied to the conventional fibreglass blowing wool insulating material, which are useful additives when fibreglass is used for its designated objective as building insulating material, do not significantly compensate for the tendency which fibreglass possesses to sink when the insulating material is used to clean aquatic petroleum spills. And U.S. Pat. No. 5,215,407 discloses a product for cleaning petroleum based on fibreglass, which, although capable of floating, is nevertheless somewhat difficult to manufacture and to use.

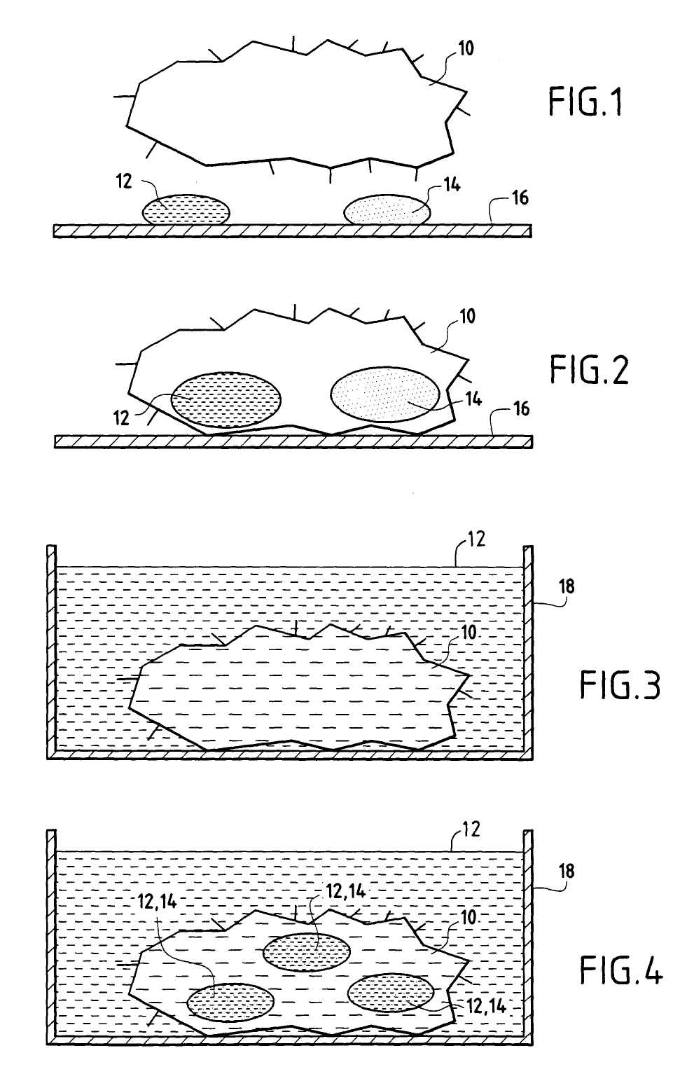

FIG. 1 (prior art) illustrates a mass of conventional bulk fibreglass blowing wool 10 (density=2.55 g/cm³) suspended above discrete quantities of water 12 (density=1.0 g/cm³) and of SAE 30 grade engine oil 14 (density=0.95 g/cm³), placed on a solid substrate 16 before bringing the fibreglass into contact with the oil and the water.

FIG. 2 (prior art) shows the fibreglass 10 in contact with the substrate 16 and the adsorption of the oil and of the water which are symbolized respectively by the ovals 12 and 14. FIG. 2 reflects the fact that the conventional bulk fibreglass 10 manifests excellent characteristics of wicking effect both relative to the water and relative to the oil and adsorb without any discrimination both liquids. In fact, the water is adsorbed more rapidly than the oil because of its lower viscosity.

FIG. 3 (prior art) shows a bundle or a mass of conventional fibreglass 10, submerged in a volume of water 12, placed in a container 18, shortly after introducing the fibreglass onto the surface of the water. Because of the excellent properties of wicking of the fibreglass, coupled with its density which is approximately 2 ½ times greater than that of water, the mass rapidly adsorbs its available capacity of water and sinks to the bottom of the container 18.

FIG. 4 (prior art) describes a mass of fibreglass blowing wool insulating material CertainTeed InsulSafe III® 10, shortly after adsorption of a quantity of Brass River crude petroleum which had been previously spilled on a quantity of water 12 in the container 18. However, the fibreglass 10 rapidly adsorbs and without discrimination both the water and the petroleum (ovals 12, 14). Once the water 12 and the petroleum 14 penetrate and saturate the matrix of fibres, the fibreglass rapidly sinks.

Consequently, a need is observed relating to a hydrophobic and oleophilic sorbent material which is useful for treating aquatic and nonaquatic petroleum-based pollutants. The material should preferably manifest high floatability in the event of a use in aquatic environments, and should be comparatively inexpensive and easy to manufacture and to use.

The subject of the present invention is first, in a first variant, a “sorbent” material comprising a fibrous material, in particular loose fibres, which is at least partially coated with an oleophilic coating which is predominantly and in particular essentially composed of silicone(s). It is defined more precisely in claims 1 to 8. “Predominantly” is understood to mean a quantity by weight of at least 50% of the coating, and “essentially” is understood to mean a quantity by weight of at least 80 to 90% of the crating. The invention also relates to the method of producing such a “sorbent” material, in particular defined in claims 9 and 11 and its applications defined in claim 12.

The invention, in its first variant, becomes more easy to understand from the following description of the preferred embodiments of the latter, illustrated, by way of example only, in the accompanying drawings in which:

FIG. 1 is a view comparing the approximate densities of the conventional bulk fibreglass blowing wool, water and engine oil;

FIG. 2 is a view describing the undifferentiated adsorption capacity of the conventional bulk fibreglass for oil and for water;

FIG. 3 is a view of a quantity of conventional bulk fibreglass which has adsorbed water and which has then sunk in the water;

FIG. 4 is a view of a quantity of conventional bulk fibreglass which has adsorbed without discrimination oil and water and which has then sunk in the water; and

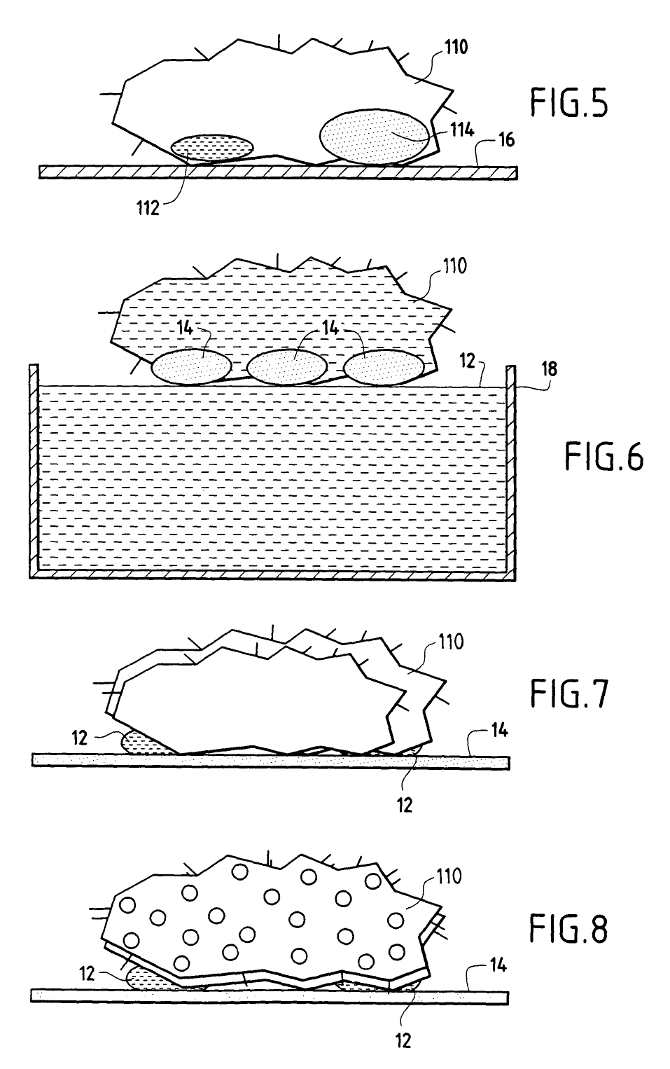

FIG. 5 is a view of a first preferred embodiment of a sorbent material in accordance with the first variant of the present invention, adsorbing oil in a selective manner compared with water;

FIG. 6 is a view of a first preferred embodiment of a sorbent material in accordance with the first variant of the present invention which has selectively adsorbed oil and continues to float on water.

During the research and development: which led to the present invention, as described below in greater detail, it was discovered that a coating predominantly (essentially) composed of silicone(s) should have the effect of causing the floatation of the insulating material made of mineral fibres of the bulk fibreglass type if brought into contact with a mass of water. However, it has been established that the fibreglass blowing insulating material InsulSafe III® sinks rapidly when it is placed in water. Although the reason for this behaviour is not completely understood, it may be that the antistatic agent based on quaternary ammonium salts is, in any manner, responsible for the substantial suppression of the silicone floatability effect.

The present invention uses oleophilic and hydrophobic fibrous sorbent materials and methods intended for the manufacture and for the use of materials of this type. The sorbent agents are useful for the elimination of hydrocarbon slicks and of similar spills affecting watercourses and land structures. In one embodiment, the fibrous materials comprise mineral (glass) fibres in bulk (that is to say unbound), commonly known by the term “blown wool”, “wool for blowing” or “blowing wool”, or fibreglass particles. In another embodiment, the fibrous materials comprise loose cellulosic fibres. The invention however includes fibres, whether they are mineral or cellulosic, which are bound, that is to say sheathed with a sizing composition (generally containing resins, based on phenol-formaldehyde and urea in particular). In accordance with both embodiments, the fibrous materials are coated with a light coating of a substance which allows the fibrous materials to float in water and which consequently makes them easy to recover if used for the removal of petroleum spills from bodies of water. The coating substance is essentially composed of silicone, but may also include other constituents such as paraffin oil.

The sorbent materials according to the invention are easier to manufacture and to use and possess floatability and sorption capacity characteristics which are comparable to or greater than those of fibrous sorbents for petroleum known up until now in the prior art.

FIG. 5 qualitatively illustrates the characteristics of the adsorption capacity of bulk fibreglass blowing wool 110, in accordance with the present invention, as a function of discrete quantities of water 112 and of SAE 30 grade engine oil 114 (“SAE” means “Society of Automotive Engineers”). The fibreglass 119 can be manufactured in accordance with any process appropriate for the production of bulk fibreglass, for example the techniques of centrifugation and gas drawing. Processes of this type are well known to persons skilled in the art. They will consequently not be discussed in detail here. After the formation of the fibreglass, however, and in accordance with one embodiment given by way of example of the present invention, the fibreglass is preferably coated with the aid of about 0.05 to about 0.10 percent by weight of silicone relative to the weight of the fibre.

If the content of silicone is substantially less than about 0.05 by weight of silicone, the fibres do not retain their floatability. There is however no scientific limit indicating how much silicone can be used. The silicone has a specific gravity of less than 1.0 grams/cm³. Given its natural floatability, 100% of the added silicone should also work. However, in practice high levels of silicone would be wasteful and would be costly. The preferred range is between 0.05% and 0.5% of silicone.

As regards the type of silicone which may be used, there may be chosen, in particular, emulsions in the form of fluids having a viscosity of about ten to a few hundreds of centistokes (for example between 50 and 400, preferably between 100 and 300 centistokes, in particular of about 200 centistokes. Their molecular mass may between 1000 and 100,000, in particular 5000 to 15,000. Preferably, they are silicones which are not reactive at room temperature, but when they are applied to the hot fibres, upon leaving centrifuges in particular, the silicone may advantageously tend to form irreversible chemical bonds with the mineral fibres, in particular with the fibreglass.

One example of silicone of internet to the invention is in particular PDMS (polydimethylsiloxane), having the chemical formula:

#

with R radicals which may be alkyls of the methyl type or an alcohol function OH. It should also be noted that various silicones are mixed in variable Proportions. The properties of these silicones vary, in particular according to the type of R radicals (or in either of the methyls is substituted) which may be alkyl or unsaturated groups, for example phenyls, propyls, substituted/branched alkyls. This choice of radicals attached to the silicon makes it possible to modify the properties of the silicon, in particular its degree of hydrophobicity.

The class may be coated by the following process, by way of example: when the fibreglass leaves a centrifuge basket (for example a unit for forming fibres by centrifugation), it is immediately subjected to spraying with the aid of the silicone emulsion (in aqueous phase). The silicone emulsion is pumped from a storage tank Through a system of flexible pipes in the direction of a small 0.5 inch (1.27 cm) stainless steel pipe which has been made in the form of a circular ring having a diameter of approximately 36 incites (0.9 m). Several spray nozzles may be situated around this ring. The spray nozzles are directed towards the centre. When the fibres are formed, the pressurized aim introduced during the formation of the fibres brings the fibres towards the bottom and through this sprang ring. The newly formed fibres are coated with the silicone emulsion as they pass through the ring at a very high speed.

The product according to the invention preferably uses no binding agent (for example a formophenolic resin) and provides an oleophilic, hydrophobic product in bulk. The silicone is the only hydrophobic chemical constituent (several of them may be used in the form of a mixture). The silicone creates a product which is hydrophobic and which, once blown, allows the fibre to expand after a high compression. This product possesses numerous advantages compared with the prior art products, such as the bound felt insulating material having from 0.5 to 3.0% of silicone described in U.S. Pat. No. 5,078,890 to which reference was made above.

It was observed that a silicone coating promotes the floatability of the fibreglass 110 while conferring oleophilic and hydrophobic characteristics on it. A preferred silicone is the product Dow Silicone 346 marketed by the company Dow Chemical Company of Midland, in Maryland. Since it is preferable to deliver the fibreglass 110 by the pneumatic route in the case of a use for the treatment of large petroleum spills, the fibreglass 110 may be optionally coated with the aid of 1.0% to 3.0% of oil(s) in a sufficient quantity to act as agent for removing dust, in particular during the fibreglass delivery phase. The oil may be for example the oil “PROREX 100®” marketed by the company Mobil Corporation or the product “SUNPAR LW110®” marketed by the company Sun Company. Any oil or any other substance which is appropriate for the removal of dust and which does not have a material impact on the oleophilic and hydrophobic advantages conferred by the silicone could however be acceptable in the perspective of the intended objectives of the present invention. A preferred composition includes 0.27% of silicone and not more than 1.8% of oil. As indicated in FIG. 3, the fibreglass 110 preferably absorbs the petroleum 114 rather than the water 112.

An exemplary paraffin oil which may be added to prevent dust Sand irritation has a viscosity of between about 18.7 and 22.0 cSt at 40° C., a minimum flash point of 380° F., and a specific gravity of about 0.862 at 60° F.

Simulated petroleum slicks were produced in order to compare the relative floatability characteristics of the conventional bulk fibreglass blowing wool insulating material and the bulk fibreglass blowing wool, with silicone coating, of the present invention. Each petroleum slick was prepared in the laboratory by adding 15.0 grams of Brass River crude petroleum to 400.00 grams of lap water, maintained in separate reservoirs at room temperature. 1.0 gram of shredded fibreglass blowing wool insulating material CertainTeed InsulSafe III® was then placed in a container and 1.0 gram of bulk fibreglass blowing wool, with silicone coating, in accordance with the present invention, was placed in the other container. Within about one minute, each fibreglass sample substantially adsorbed the entire petroleum. The sample of fibreglass blowing wool insulating material CertainTeed Insulsafe III® sank rapidly. On the contrary, the sample of bulk fibreglass blowing wool, according to the present invention, whose coating is essentially composed of silicone continued to float practically indefinitely.

FIG. 6 shows a mass of bulk fibreglass blowing wool, with silicone coating 110, in accordance with the present invention, floating on a volume of water 12 contained in the container 18. The fibreglass 110 adsorbs the petroleum (ovals 14) substantially excluding the water. In fact, in the event of a use for cleaning aquatic petroleum spills, the fibreglass 110 can be easily and completely recovered once saturated with petroleum. Consequently, the risk of the fibrous material impregnated with petroleum sinking and possibly becoming lost at the bottom of a body of water is eliminated in an efficient manner.

During the research and development which led to the present invention in its first variant, it was observed that in addition to the inorganic mineral fibres such as fibreglass blowing wool, a coating essentially composed of silicone also improves the sorption capacity of bulk and moreover untreated (or bound) cellulosic fibrous materials. Untreated cellulosic figures such as ground newspaper, wood pulp and similar products both adsorb and absorb the liquid, whereas the entreated fibreglass adsorbs the water. However, just like the untreated fibreglass, the untreated cellulosic fibres indiscriminately sorb the water and the petroleum. Consequently, the untreated cellulosic fibres, like the untreated mineral fibres, tend to sink rapidly in the case of a use for cleaning aquatic petroleum spills.

In accordance with the present invention, it was observed that when cellulosic fibres are treated with the aid of a silicone which is the same or which is similar in quality and in quantity to that applied to the fibreglass 110 discussed above, the coated cellulosic fibres selectively adsorb and absorb the petroleum at the expense of the water. Consequently, the cellulosic fibres coated with silicone manifest a substantially higher floatability compared with that of the untreated cellulosic fibres. Specifically, the untreated cellulosic fibres tend to sink within a few minutes, whereas the cellulosic fibres coated with silicone have proved to adsorb and absorb the petroleum and continue to float for a period of between about 30 and about 60 minutes.

In accordance with either embodiment of the present invention, the silicone-coated fibrous materials which are provided here are sorbents which are effective for petroleum. In particular, the silicone-coated fibreglass 110 and the cellulosic fibres have demonstrated a sorption capacity equal to more than 20 times, respectively more than 15 times, their own weight of SAE 30 grade engine oil.

Although the invention in its first variant has been described in terms of exemplary embodiments, it is not limited thereto. Quite on the contrary, the accompanying claim should be understood in a broad sense to include other variants and other embodiments of the invention which could be made by persons skilled in the art without departing from the context and the scope of the invention.

Thus, in its first variant, the “bulk” fibrous material, without a sizing composition, is preferred. It has the advantage of being capable of being blown. At the industrial level, the step of spraying the sizing composition and the step for its crosslinking by passing the fibrous material in an oven are both avoided. However, the invention also applies to bound fibres. It is possible to discharge the emulsion containing thee hydrophobic/oleophilic silicone(s) onto the fibres once they have been sized by a spray ring placed under the ring used to spray the size, under the centrifugation plates. These sized and then treated fibres can then be used in the form of mats or can be shredded in the form of flakes.

It is also envisaged in the context of the invention to treat fibrous material already in the form of a cushion of fibres, by spraying the emulsion onto the surface of the cushion in particular.

It is possible to combine several silicones in the emulsion used (whose aqueous solvent evaporates during the preparation of the product).

The fibrous material according to the invention in its first variant is very effective for absorbing any type of oil or hydrocarbon, in particular those of these products which have a viscosity of between 8000 and 15,000 centipoises. Generally, it is capable of absorbing between at least 15 and 50 times its weight of this type of oil/hydrocarbon.

As seen above, a particularly advantageous application relates to the treatment of oil slicks, for selectively absorbing pollutants without sinking to the bottom of the water. Other applications are also promising, in particular in the field of filtration. Finally, it is also possible to use this type of material for “sponging” petrol or used engine oil from cars or lorries, in particular in garages. This material may thus be available in the form of pads which are placed at the appropriate site in order to recover the used engine oil for example.

The present invention also relates, in a second variant, to sorbent materials suitable for absorbing/adsorbing liquids, in particular aqueous liquids, in particular with the aim of recovering various types of pollutants/effluents soluble in an aqueous phase or in certain organic solvents.

The same type of fibrous material as in the first variant is targeted. The sorbent materials are useful in medical applications, personal hygiene applications and applications for recovering polluting materials, among others. Fibrous materials such as wool and felt, including fibreglass materials, have been used for such applications. FIG. 7 illustrates a mass of traditional fibreglass insulating material 10 in contact with a quantity of water 12 placed on a solid substrate 14.

U.S. Pat. Nos. 5,215,407 and 5,078,890, for example, describe respectively the use of bulk (that is to say unbound) fibreglass and as felt (that is to say bound) fibreglass as a means for cleaning spills of oil and of other liquid polluting materials. U.S. Pat. No. 5,215,407 describes the use of shredded blowing fibreglass bundles for the absorption of materials such as oil, from water and from other surfaces. Fox such spills, fibreglass is preferred which preferably absorbs the oil rather than the water. U.S. Pat. No. 5,078,890 describes the use of felts composed of mineral fibres for the absorption of petroleum products from bodies of water. The felts include glass wool or rock wool, and comprise highly compressed fibres. Before the compression, the fibres are cut into particles of less than 4 cm. The fibres are compressed with a binding agent which is preferably made of a water-repelling material, thus strengthening the hydrophobicity of the felts. Such hydrophobic materials may not be sufficient for the absorption of water and of aqueous liquids.

Consequently, there is a continuous need for materials capable of sorbing liquids, in particular water-soluble liquids and water-based liquids. One aspect of the invention in its second variant is therefore a sorbent material comprising a material made of fibreglass and at least one hydrophilic particulate material.

Another aspect of the invention is a method of sorbing a liquid, comprising bringing the liquid into contact with a sorbent material comprising a material made of fibreglass and at least one hydrophilic particulate material.

The invention according to the second variant is the subject of claims 13 to 19.

FIG. 7 is a view illustrating the characteristic capacity of a traditional material made of fibreglass to sorb water;

FIG. 8 is a view, similar to FIG. 7, of a sorbent material made of fibreglass according to the present invention, for water; and

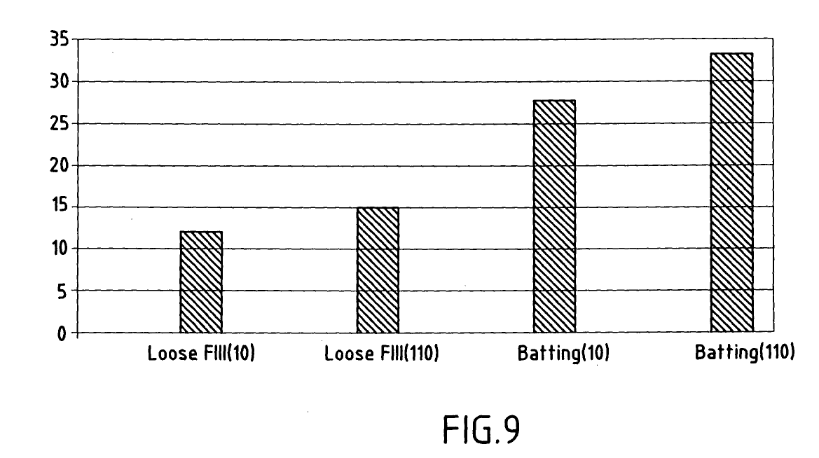

FIG. 9 is a graphic illustration of the relative water-sorbing powers of several samples of traditional materials made of fibreglass and of sorbent materials made of fibreglass according to the present invention.

It was observed that it is possible to use mineral fibres, for example fibreglass, in association with absorbent polymeric materials in order to form sorbent materials. The sorbent materials are particularly useful for the absorption of water and of aqueous liquids. Depending on the composition of the polymeric particles, the inflammability of the materials of the invention may be reduced in comparison with traditional absorbent materials comprising fibres. The sorbent materials of the present invention offer improved sorption compared with traditional fibrous absorbent materials and traditional absorbent materials containing absorbent particles.

The term “sorbent” has the same meaning as in the first variant (the absorption of a liquid means that the liquid penetrates inside the sorbent material, whereas the adsorption of a liquid means that the liquid is attracted and maintained at the surface of the sorbent material).

The sorbent materials of the present invention may be called “super-sorbent”. The term “super-sorbent” designates materials comprising sorbent particles, in addition to sorbent materials made of mineral fibres (fibreglass), and may absorb several times their weight, such as 10 or fifteen times their weight, of liquid. The sorbent particles offer an improved sorbent power compared with the materials made of mineral fibres alone.

FIG. 8 illustrates a mass of sorbent material made of fibreglass 110 in accordance with the present invention, in contact with and adsorbing a quantity of water 12 placed on a solid substrate 14. The fibreglass 110 may comprise a mass of unbound bulk fibreglass, or bound fibreglass, such as an insulation layer. Bulk mineral fibre are commercially available, for example, in the form of fibreglass (or rock fibre) insulation commonly called “blowing wool” insulation. The bound fibrous material may comprise a binder such as a hardened phenolic binder or the like (this binder is generally derived from the drying and the crosslinking of aqueous-based sizing compositions containing a resin based on phenol, formaldehyde and generally urea). Examples of appropriate fibrous materials intended to be used in accordance with the present invention comprise a blowing insulation Insul-Safe III® manufactured by Certain Teed Corporation of Valley Forge, Pa.; a blowing insulation Rich-R manufactured by Johns Manville of Denver, Colo.; and an insulation Thermacube® manufactured by Owens-Corning Corp. of Toledo, Ohio. The sorbent material made of mineral wool of the invention comprises, in addition, a quantity of hydrophilic sorbent particles 16 dispersed in the whole mass of fibres. If it is desired, the sorbent materials of the invention may be placed in a sock or an arrow, and the fibreglass material may be shredded, as described in U.S. Pat. No. 5,215,407, the disclosure of which is integrally incorporated into the present application by way of reference. If it is desired, the materials may also comprise particles of additional materials, such as cork or polystyrene foam.

For the particles 16, it is possible to use any commercially available hydrophilic particulate material capable of absorbing several times its weight of water or of aqueous solution, preferably at least about 10 to about 100 times its weight. For example, the particles 16 may comprise modified starches or acrylic polymers of high molecular weight containing hydrophilic groups, such as those described in U.S. Pat. No. 4,429,001, the disclosure of which is integrally incorporated into the present by way of reference. U.S. Pat. No. 4,429,001 describes sorbent particles composed of modified dietary searches and acrylic polymers of high molecular weight containing hydrophilic groups for the purpose of absorbing water, and absorbent alkylstyrene particles for the purpose of absorbing liquids other than water. Other appropriate particles are described in U.S. Pat. No. 3,670,731, the disclosure of which is integrally incorporated into the present by way of reference. U.S. Pat. No. 3,670,731 describes the use of particles composed of a colloidal material, in combination with a supporting sheet, for the purpose of sorbing fluids. The colloidal material is composed of a hydrocolloidal polymer having a particular degree of crosslinking, such that it is insoluble in water but swells when it absorbs liquid. The polymers described comprise crosslinked polyacrylamides, crosslinked sulphonated polystyrene and mixtures thereof. Still other appropriate particles comprise crosslinked polymethacrylates and polyacrylates, and crosslinked acrylate/methacrylate copolymers. Other appropriate polymeric materials suitable for the particles used in the present invention are polymers formed from acrylic acid or its salts, copolymerized with at least one other hydrophilic monomer, and other polymers described in U.S. Pat. No. 4,914,170, the disclosure of which is integrally incorporated into the present by way of reference. Crosslinked polyacrylate particles useful in the methods and the compositions of the present invention comprise those sold by Emerging Technologies Inc. of Greensboro, N.C.

When particles are used in combination with fibreglass materials in the methods and compositions of the present invention, the preferred quantity of particles will in general be determined by factors such as the desired absorbent power, as a compromise with the cost. For example, the quantity of particles used may be about 5 percent by weight to about 20 percent by weight (occasionally up to 40% by weight), preferably about 10 percent by weight to about 15 percent by weight, relative to the weight of the fibrous material. The particle size is not critical and may have for example a mean diameter of about 50 to about 3000 micrometres, preferably of about 75 to 1500 micrometres. Although the illustrative size ranges are provided as mean diameters, it is not necessary for the particles to be spherical. On the contrary, the particles may be in any form and, in the case of non-spherical particles, the illustrative mean diameters cited above designate the largest size of a nonspherical particle. A mixture of two types of particles or more may be used.

The particles 16 may be combined with mineral fibres 10 by any method known to persons skilled in the art for the essentially uniform dispersion of the particles in the whole mass of fibres. For example, the particles 16 and the fibreglass 10 may be conjointly placed in a vessel (not illustrated), the vessel then being vigorously stirred for a sufficient period to impregnate the fibreglass with particles. The duration and intensity of stirring will vary according to the fibrous density of the fibreglass 10 and the size of the particles 16. As a variant, the fibreglass 10 may be impregnated with particles 16 at the time of manufacture in a manner similar to that disclosed in U.S. Pat. No. 3,670,731. However, the particles 16 are preferably incorporated into fibreglass 10 by stirring at a speed and for a duration which are sufficient t, disperse the particles essentially uniformly in the whole fibrous matrix.

The present invention, in its second variant, is further described in the following examples. The examples are purely illustrative of the present invention and should not be interpreted as limiting the scope of the invention in any way.

### EXAMPLES

Tests were carried out comparing the sorbent power of bulk and bound traditional mineral fibres (fibreglass) 10 and of bulk and bound sorbent fibreglass 110. Four samples were prepared, each sample comprising 30 grams of fibreglass. The unbound and bound samples 110 comprised in addition 4 grams (13.3 percent by weight, relative to the weight of fibreglass) of crosslinked polyacrylate particles 16 from Emerging Technologies Inc. of Greensboro, N.C. Each of the four samples was placed in a tank filled with water. Each sample was allowed to sorb the water until it was completely saturated. Next, the samples were placed on a screen having a mesh of ¼ inch and they were allowed to drain freely. After five minutes, the samples were removed from the screens and weighed in order to determine the total quantity of water retained by each sample.

The results are illustrated in FIG. 9. As illustrated, the sample containing traditional bulk fibreglass 10 sorbed approximately 12 times its weight of water, whereas the sample containing bulk fibreglass 110 and particles according to the present invention sorbed about 15 times its weight of water. The sample containing traditional bound batting glass fibres 10 sorbed approximately 28 times its weight of water, whereas the sample containing bound bat-ting glass fibres 110 and particles according to the present invention sorbed approximately 33 times its weight of water.

More generally, the unbound fibrous materials combined with particles according to the invention are capable of absorbing between 10 and 20 times their weight of water, whereas the bound fibrous materials combined with the same particles are capable of absorbing between 20 and 40 times their weight of water.

Thus, FIG. 9 illustrates the improved capacity of bulk and bound fibreglass materials 110 modified with particles 116 in accordance with the present invention, in its second variant, to sorb water compared with the capacity of traditional bulk and bound fibreglass materials.

The sorbent materials of the present invention, in its second variant, may be used, for example, for cleaning spills of water-soluble pollutants in a sheet of water. When they are used to remove a water-soluble polluting material discharged in a body of water, the sorbent materials may be simply thrown over the spill, the polluting material thus being rapidly sorbed at the same time as its aqueous solvent. The same method may be used when the polluting materials are in aqueous solution and are discharged over land structures. When the spill is land-based and the polluting material is not dilute, the polluting material may be diluted with water before spreading the sorbing material over it, in order to ensure complete sorption of thee polluting material.

It is understood that these various modifications of the details, including of the materials, which have been described and illustrated above in order to explain the nature of the invention in this second variant, may be performed by persons skilled in the art without departing from the principles and from the scope of the invention. Although the invention has been described in terms of illustrative embodiments, it is not limited thereto. On the contrary, the appended claims should generally be interpreted as including other variants and embodiments of the invention which may be performed by persons skilled in the art without departing from the scope and the range of equivalents of the invention.

The fibrous material with particles according to the second variant of the invention can thus “sorb” a quantity of water-soluble pollutants, in particular industrial liquid effluents, paints, cooling liquid used in vehicles, industrial waste from electroplating or from the refining of gold. The invention is also effective with respect to numerous nonaqueous solvents, in particular chlorinated solvents such as trichloroethylene.

1. Sorbent material comprising a fibrous material combined with an oleophilic coating and/or with a hydrophilic particulate material.

2. Sorbent material according to claim 1, characterized in that the fibrous material comprises mineral fibres of the fibreglass or rock fibre type, or cellulosic fibres.

3. Sorbent material according to claim 2, characterized in that the fibres are bound or unbound, in bulk.

4. Sorbent material according to one if claims 1 to 3, characterized in that the oleophilic coating predominantly comprises, in particular essentially, silicone(s).

5. Sorbent material according to one of the preceding claims, characterized in that the said coating is provided in a quantity of about 0.01 to about 1.0%, in particular from 0.05 to 0.5% by weight of silicone(s) relative to the weight of the fibres.

6. Sorbent material according to one of the preceding claims, characterized in that the said coating comprises, in addition, at least one agent for removing dust, in particular in the form of oil(s).

7. Sorbent material according to claim 6, characterized in that the coating comprises from 1.0% to 3.0% of oil(s).

8. Sorbent material according to one of the preceding claims, characterized in that it is provided with an oleophilic coating, in that it is capable of absorbing at least from 15 to 50 times its weight of oils or hydrocarbons which have in particular a viscosity of between 8000 and 15,000 centipoises and in that it has a high floatability with respect to water.

9. Method of manufacturing a sorbent material according to one of the preceding claims characterized in that a quantity of fibrous material in particular unbound, is selected, and in that it is at least partially coated with an oleophilic coating predominantly comprising, in particular essentially, silicones).

10. Method according to claim 9, characterized in that the fibrous material is based on mineral fibreglass or rock fibres and in that there is sprayed onto the said fibres an emulsion containing the silicone(s) under the devices for manufacturing the said fibres, in particular under the centrifugation plates, before they are assembled.

11. Process according to claim 9 or claim 10, characterized in that an emulsion containing the silicone(s) is sprayed onto the fibrous material already in the form of a cushion.

12. Application of the sorbent material combined with an oleophilic coating according to one of claims 1 to 8 or obtained according to the method in accordance with one of claims 9 to 11 to the depollution of stetches of water with oils/hydrocarbons, as filtration material, or for absorbing used engine oils/hydrocarbons for vehicles.

13. Sorbent material according to one of claims 1 to 3, characterized in that the quantity of hydrophilic particulate material is about 5 percent by weight to about 20 percent by weight, relative to the weight of the fibrous material.

14. Sorbent material according to one of claims 1 to 3 or according to claim 13, characterized in that the hydrophilic particulate material is chosen from the group consisting of modified starches, acrylic polymers with high molecular weight having hydrophilic groups, a crosslinked polyacrylamide, a crosslinked sulphonated polystyrene, crosslinked polyacrylates, crosslinked polymethacrylates, crosslinked copolymers of acrylates and of methacrylates, and mixtures thereof.

15. Sorbent material according to one of claims 1 to 3 or either of claims 13 and 14, characterized in that the mean particle size of the particulate material is between 50 and 3000 micrometres, in particular between 75 and 1500 micrometres.

16. Sorbent material according to one of claims 13 to 15, characterized in that it is capable of absorbing at least between 10 and 20 times its weight of water if it uses an inbound fibrous material, and at least between 20 and 40 times its weight of water if it uses a bound fibrous material.

17. Method of manufacturing a sorbent material according to one of claims 1 to 3 or according to one of claims 13 to 16, characterized in that a quantity of fibrous material and a quantity of particulate material are selected, and in that a homogeneous dispersion of the particulate material in the fibrous material is obtained by mechanical stirring.

18. Method of manufacturing a sorbent material according to one of claims 1 to 3 or according to one of claims 13 to 16, characterized in that the particulate material is introduced in the form of a colloidal suspension into the fibrous material.

19. Application of the sorbent material combined with a hydrophilic particulate material according to one of claims 1 to 3 or 13 to 16 or obtained according to the method in accordance with claim 17 or claim 18 to the absorption of organic solvents of the trichloroethylene type or to the absorption of pollutants soluble in welter such as paint, cooling liquid and industrial effluents.
